(19) United States
(12) Patent Application Publication
(10) Pub. No.: US 2015/0073947 A1
(43) Pub. Date: Mar. 12, 2015

(54) PLANOGRAM ATTRIBUTE RESOLUTION

(71) Applicant: Sears Brands, LLC, Hoffman Estates, IL (US)

(72) Inventors: Amy Higgins, Smyrna, GA (US); Heidi Wallmeier, Arlington Heights, IL (US); Tony Shanks, Byron, GA (US); Lindsay Phelps, Deposit, NY (US); Brandon Wolf, Moseley, VA (US)

(73) Assignee: Sears Brands, LLC, Hoffman Estates, IL (US)

(21) Appl. No.: 14/025,336

(22) Filed: Sep. 12, 2013

(51) Int. Cl. G06Q 10/08

(52) U.S. Cl. CPC G06Q 10/087
USPC 705/28

(57) ABSTRACT

Methods, systems, and computer readable storage media are disclosed that aid in the creation and/or updating of floor plans and associated planograms. Some embodiments utilize an assignment table to maintain relationships between floor plans and associated planograms. Some embodiments also locate planograms for display fixtures of a floor plan based on attributes for the display fixture and products to be displayed.

### FIELD OF THE INVENTION

Various embodiments relate to planograms, and more particularly, to creating and/or modifying floor plans and associated planograms.

### BACKGROUND OF THE INVENTION

For any business, customer satisfaction is paramount to retaining customers. For retail stores, customer satisfaction is generally linked to the overall shopping experience provided. A variety of factors may play a role in the provided shopping experience such as, for example, a customer's perception of price, product availability, customer service, friendliness of employees, cleanliness of the store, and the presentation of products within the store. The presentation of products includes factors such as whether the products are displayed in a pleasing fashion, whether the products are easy to locate, whether the products are well stocked, and whether the products are within easy reach.

Consequently, a retailer may attempt to design product displays that are visually pleasing to its customers and that enable a customer to easily locate and select products for purchase. A retailer may graphically capture and present a designed display in a planogram. A planogram is a layout, or blueprint, that assigns each product to a specific location on specific shelf in the retail store. Planograms typically provide other information associated with the products to be displayed, such as, for example, the quantities of each product and corresponding pricing information (e.g. labels).

A retailer may employ a team to develop planograms for all store locations. Because individual retail stores often have different physical dimensions and configurations, the team may need to design a unique floor plan for each retail store. Moreover, each floor plan may reference many different planograms that each specify the products and arrangement of such products to be placed on the particular shelving and/or display fixture. Floor plans and their associated planograms may each have a separate effective date upon which the corresponding floor plan and/or planogram goes live and by which retail store personnel are expected to implement the specified product placement.

A retailer may have thousands of retail stores that each have specific product display needs. Developing appropriate floor plans and/or planograms for such a large number of retails stores that may each have different physical layouts, product mixes, shelving configurations, etc. can quickly become an unwieldy task. Thus, tool are needed that aid the person and/or persons assigned to creating and modifying floor plans and associated planograms for the retail stores.

Limitations and disadvantages of conventional and traditional approaches should become apparent to one of skill in the art, through comparison of such systems with aspects of the present invention as set forth in the remainder of the present application.

### BRIEF SUMMARY OF THE INVENTION

Apparatus and methods for creating and/or modifying store floor plans and associated planograms are substantially shown in and/or described in connection with at least one of the figures, and are set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 shows a floor plan and planogram management system in accordance with an embodiment of the present invention.

FIG. 2 shows an embodiment of a floor plan managed by the system of FIG. 1.

FIG. 3 shows an embodiment of a planogram managed by the system of FIG. 1.

FIG. 4 shows a flowchart for an embodiment of a method that may be used by the system of FIG. 1 to manage relations between floor plans and planograms. may be used by the e-commerce system of FIG. 1 to rank, select, and/or identify similar products.

FIG. 5 shows a flowchart for an embodiment of a method that may be used by the system of FIG. 1 to find or create planograms based on attributes of a floor plan.

FIG. 6 shows an embodiment of a computer system that may be used to implement one or more aspects of the system 100 shown in FIG. 1

### DETAILED DESCRIPTION OF THE INVENTION

Aspects of the present invention are related to methods, systems, and computer readable media that aid persons tasked with creating and/or modifying floor plans and associated planograms for one or more stores. More specifically, certain embodiments of the present invention relate to apparatus, hardware and/or software systems, and associated methods that aid such persons by maintaining a database of planograms in a manner that permits locating a previously created planogram that is suitable for a particular product display fixture. Such a database of planograms may greatly reduce the workload of persons tasked with creating and/or modifying floor plans and associated planograms as such persons may use and reuse such planograms across stores.

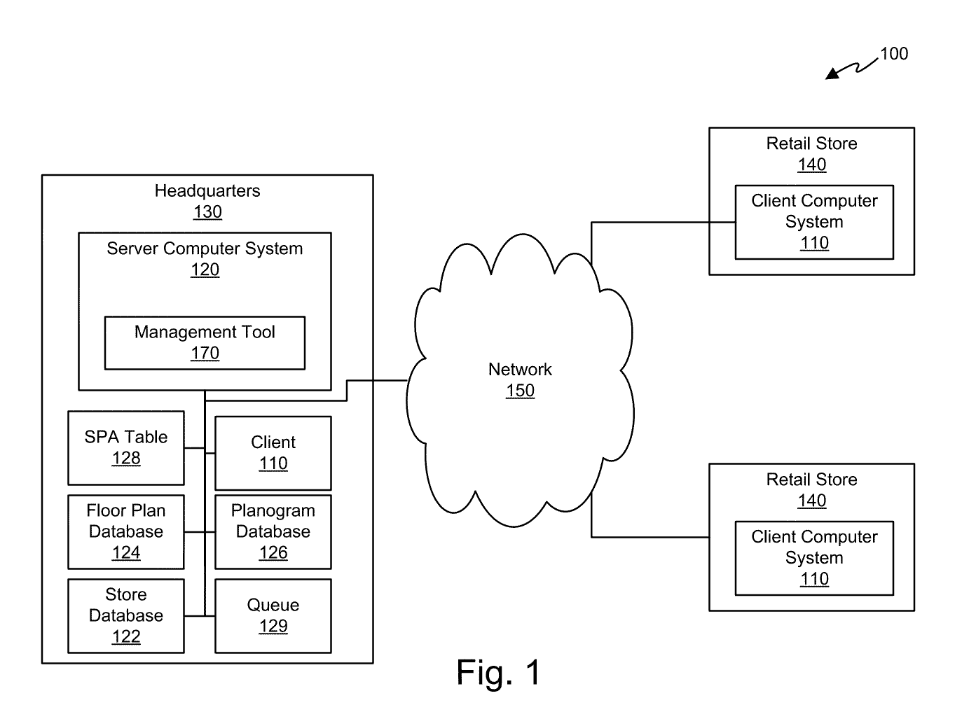

A floor plan and planogram management system 100 is shown in FIG. 1. The management system 100 may include client computing devices and/or systems 110 and server computing devices and/or systems 120. As depicted, the client computer systems 110 and server computer system 120 may be distributed across various locations such as, for example, a retail store headquarters 130 and retail stores 140. Furthermore, a network 150 may operably couple the client computer systems 110 to the server computer system 120. The network 150 may include a number of private and/or public networks such as, for example, wireless and/or wired LAN networks, cellular networks, and the Internet that collectively provide a communication path and/or paths between the client computer systems 110 and the server computer systems 120.

Each client computer system 110 may include a desktop, a laptop, a tablet, a smart phone, and/or some other type of computing device which enables a user to communicate with the server computer system 120 via the network 150. In particular, the client computer systems 110 may permit store personnel to create, modify, distribute, and/or receive floor plans and associated planograms for retail stores 140. The server computer system 120 may include one or more web servers, database servers, routers, load balancers, and/or other computing and/or networking devices. In particular, the server computer system 120 may be configured to provide a floor plan and planogram management tool 170 via the client computer systems 110 and network 150 that aid in the creation and/or modification of floor plans and associated planograms.

To this end, the server computer system 120 may include and/or maintain several computer-readable databases, tables, queues, and/or other data structures. In particular, the server computer system 120 may comprise one or more mass storage devices and/or database servers that store and maintain a retail store database 122, a floor plan database 124, a planogram database 126, a store planogram assignment (SPA) table 128, and attribute reconciliation process (ARP) queue 129. The retail store database 122 may include information about each of the retail stores 140 and each store 140 may have a corresponding retail store database key RS_{KEY} which may be used to retrieve information for the respective retail store 140. The floor plan database 124 may store floor plans for each retail store 140 and each stored floor plan may have a corresponding floor plan database key FP_{KEY} which may be used to retrieve the respective floor plan from the database 124. Moreover, the floor plan database 124 for each floor plan may store data that specifies the physical layout of the respective store 140, physical properties (e.g., height, length, depth, type, number of shelves, etc.) for each display fixture in the store, and the location of each display fixture within the retail store 140.

The planogram database 126 may store planograms that specify various aspects (e.g., product mix, position and layout of the products, etc.) for a particular display fixture. Like the database 124, each stored planogram may have a corresponding planogram database key POG_{KEY} which may be used to retrieve the respective planogram from the database 126. The SPA table 128 may be implemented as another database which manages assignments of planograms in the planogram database 126 to fixtures of a particular floor plan in the floor plan database 124.

As noted above, the client and/or server computer systems 110, 120 may provide the management tool 170. The management tool 170 may permit personnel to create, modify, distribute, and/or receive floor plans and associated planograms. In particular, the management tool 170 may be implemented using one or more software and/or firmware modules. Such modules may comprise instructions that are executed by the client computer systems 110 and/or the server computer system 120. The management tool 170 may further work in conjunction with the ARP queue 129. In one embodiment, the management tool 170 may place a floor plan in the ARP queue 129 for processing. In particular, the management tool may store a corresponding floor plan database key FP_{KEY} for the floor plan to be processed in the ARP queue 129 in response to various triggering events. For example, the management tool 170 may place a floor plan key FP_{KEY} in the ARP queue 129 in response to personnel using a client computer system 110 to: open and modify an existing floor plan 200; create a floor plan 200 via copying or versioning an existing floor plan; delete a floor plan; change the effective date of a floor plan, and/or other triggering events.

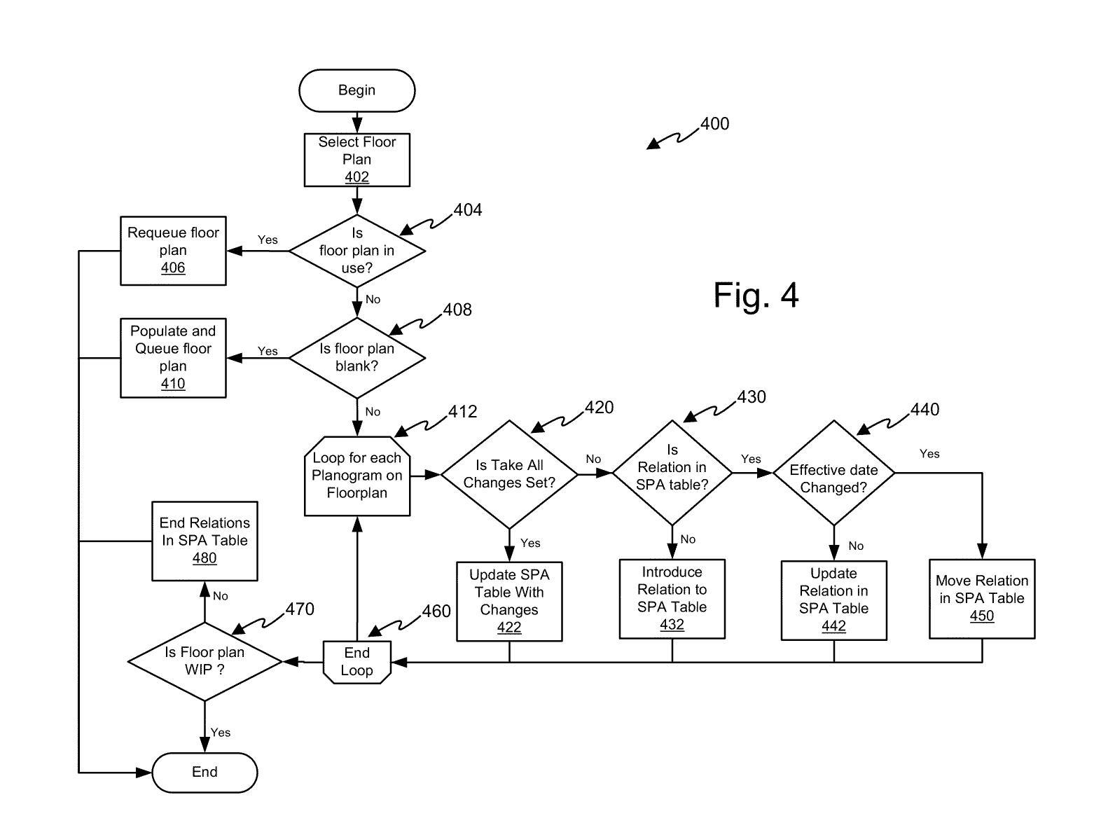

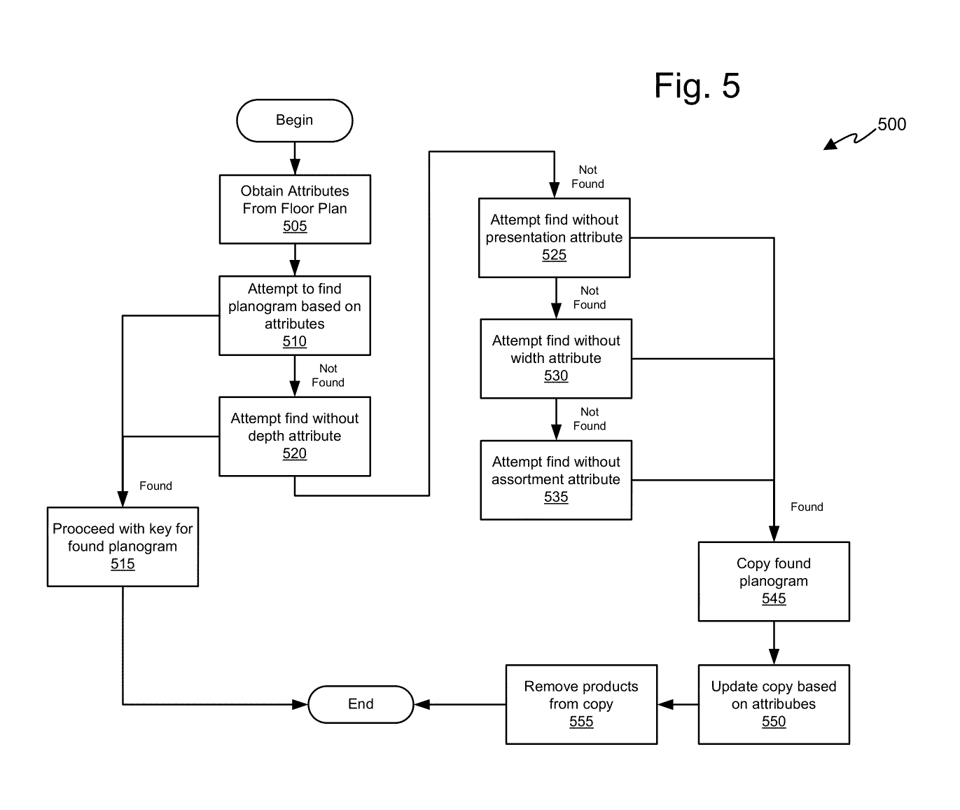

Moreover, the management tool 170 may periodically poll the ARP queue 129 to determine whether there are floor plans 200 to be processed. Alternatively, the ARP queue 129 may signal and/or otherwise request the management tool 170 to process a floor plan 200 when one or more floor plans 200 are present in the queue 129. In one embodiment, the ARP queue 129 may be implemented as a first-in, first-out (FIFO) queue. In such an embodiment, the management tool 170 may select the floor plan 200 referenced at a head of the ARP queue 129 for processing. However, the ARP queue 129 and/or management tool 170 in other embodiments may implement another schemes to manage the queuing and processing of floor plans 200. Further aspects of the management tool 170 are presented below with respect to FIGS. 4 and 5.

As noted above, the floor plan database 124 may include floor plans for each retail store 140. A retail store 140 may have several departments (e.g., household goods, sporting goods, consumer electronics, etc.), sub-departments (e.g., televisions in consumer electronics, casual ware in women's apparel, etc.), and/or other areas for which the floor plan database 124 includes a floor plan. In particular, store personnel may generate and/or otherwise design a floor plan for each department, sub-department, and/or another portion of the retail store 140 as deemed appropriate.

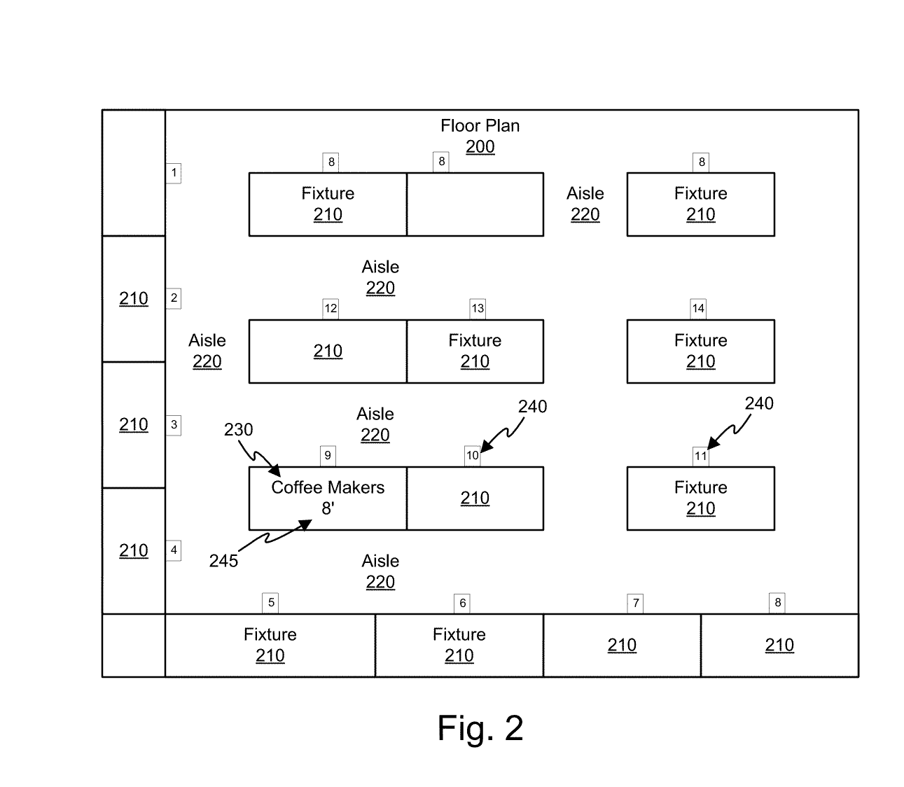

Referring now to FIG. 2, an example floor plan 200 is shown. The floor plan 200 depicts several display fixtures 210 and their location in a retail store 140. A retail store 140 may arrange display fixtures 210 in columns and rows, position display fixtures 210 along walls, hang display fixtures 210 from ceilings, and/or otherwise place or position such display fixtures 210 throughout the store 140. The floor plan 200 may graphically depict the layout or arrangement of display fixtures 210 throughout the store 140, department, sub-department, and/or other portion of the store 140. Such a layout of display fixtures 210 may form aisles 220 between display fixtures 210 through which customers may pass. By passing through the various aisles 220, a customer may view and select displayed products from display fixtures 210.

The floor plan 200 may also provide descriptive labels 230 and location references 240 for the depicted display fixtures 210. A descriptive label 230 may provide a summary (e.g., coffee makers, cutlery, etc.) of the products displayed by the respective display fixture 210. A location reference 240 may comprise a reference numeral (e.g., 10, 23, etc.) or some other indicia that uniquely identifies the display fixture 210 in the floor plan 200. In particular, the location reference 240 may be used to correlate or link a display fixture 210 to its respective planogram. As such, store personnel may use the location reference 240 of a display fixture to obtain the appropriate planogram for the display fixture 210.

The floor plan 200 may further include indicia 245 that provide physical attributes of the respective display fixture 210 such as, for example, the length, height, depth, etc. of the display fixture 210. Store personnel may use such indicia 245 to ensure the display fixture 210 corresponds to the floor plan 200 and corresponding planogram. If not, store personnel may need to either adjust or replace the display fixture 210 so that it matches the floor plan 200 or request the floor plan 200 be revised to match the display fixture 210 at the specified location. Such a revision to the floor plan 200 may also result in a change to the planogram for the display fixture 210 since the planogram was designed for a display fixture 210 having different physical attributes

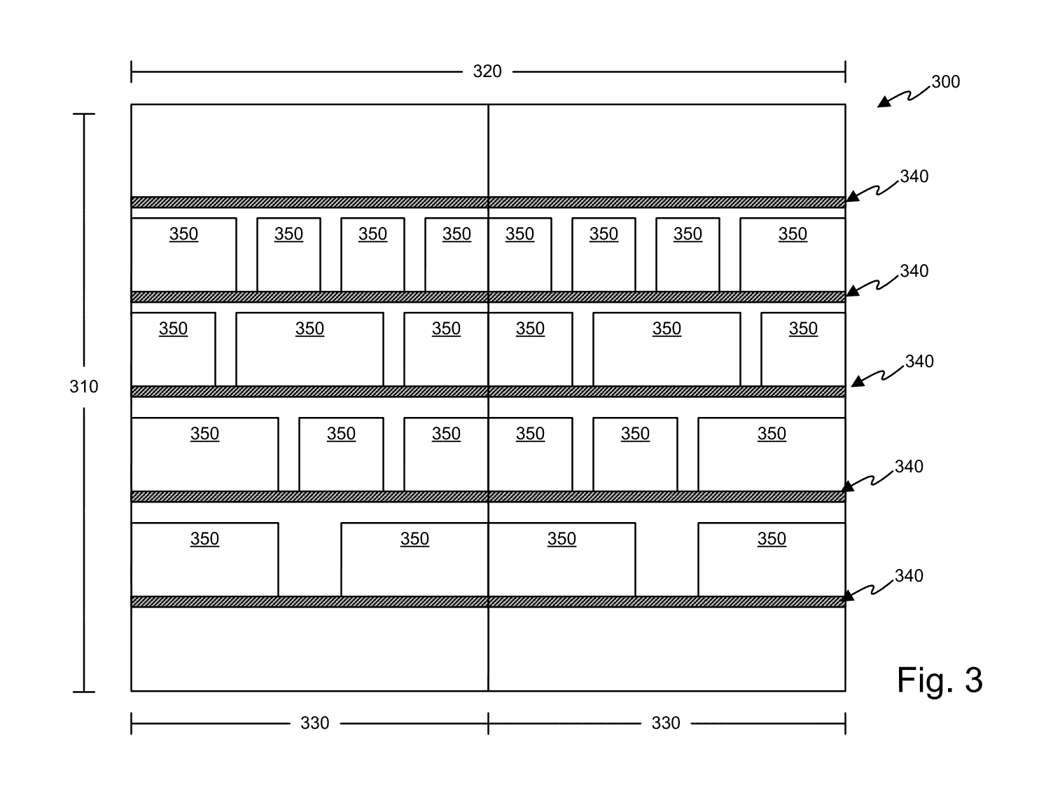

As noted above, the planogram database 126 may include planograms for display fixtures 210. Referring now to FIG. 3, an example planogram 300 for a display fixture 210 is shown. The depicted planogram 200 specifies products and the arrangement of such products on a gondola display fixture 210 that comprises several shelves. However, planograms 200 may be developed to specify products and the arrangement of such products for a vast array of different types of display fixtures 210. As such, the planogram 300 of FIG. 3 is for illustrative purposes to aid understanding of certain aspects of the system 100 and/or management tool 170.

The planogram 300 may depict physical attributes of the display fixture 210. For example, the planogram 300 may depicted the height 310, width 320, and segmentation 330 of the display fixture 210. The planogram 300 may further specify the position of each shelve 340. For example, the planogram 300 may specify the distance between each shelve 340. Besides, depicting the physical attributes of the display fixture 210, the planogram 300 may further depict and/or specify products 350 to place on the shelves 340 as well as the arrangement of such products 350 on the shelves 340. In particular, the planogram 350 may depict the placement of the products 350 as simplified blocks with a reference numeral or other indicia that direct personal to a line item of a table that provides further details regarding the products represented by such simplified blocks.

For example, each line item of the referenced table may provide a product category number, a product serial number, an indication of whether the product is new to this planogram, an indication of whether the product moved from a previous position, a universal product code for the product, a textual description of the product, the quantity of fills for that product in the planogram, the quantity of the product contained in a fill, as well as possible further information that may aid the personnel tasked with implementing the planogram 300. Some of the information present in the referenced table may also be reflected in the planogram 300. For example, the planogram may include shading and/or color coding to reflect moved products, new products, and/or portions of the planogram that are unchanged from a previous planogram implemented by the display fixture 210.

As noted above, the planogram database 126 may include planograms 300 for display fixtures 210. Each display fixture 210 of the floor plans 200 may have a corresponding planogram 300 that instructs store personnel as to which products are to be placed upon the display fixture 210 as well as the arrangement of such products on the display fixture 210. However, a retailer may have many retail stores 140 and at least some of such retail stores 140 may have similar floor plans, display fixtures, etc. As such, a single planogram 300 in the planogram database 126 may correspond to display fixtures 210 of different floor plans 200 and/or stores 140. For example, a single planogram may specify which coffee makers and the arrangement of such coffee makers on a display fixture 210 found in a first retail store 140. The same planogram may also be used to specify which coffee makers and the arrangement of such coffee makers in hundreds of other retail stores, assuming such retail stores 140 include a display fixture 210 that has the same or very similar physical attributes as the display fixture 210 of the first retail store 140. Thus, the planogram database 126 may generally include a planogram 300 for each display fixture 210 of each floor plan 200 in the floor plan database 124. However, such a planogram 300 may not necessarily be unique to a particular display fixture 210 and/or a particular floor plan 200. Instead, the planogram 300 may be used and/or otherwise linked to several display fixtures 210 and/or floor plans 200.

The floor plan database 124 and planogram database 126 may each maintain a status and effective date for each floor plan 200 and planogram 300. The status may indicate whether the floor plan 200 or planogram 300 is a Work In Progress, Awaiting Approval, Pending, Live, or Historic. When creating and/or revising a floor plan 200 or planogram 300, personnel may commit to the respective database 124, 126 before completing the floor plan 200 or planogram 300. In such situations, the management tool 170 may mark the floor plan 200 or planogram 300 as a Work In Progress. Once finished, personnel may update its status via the management tool 170 to Awaiting Approval so that the finished or proposed floor plan 200 or planogram 300 may be reviewed and approved by other store personnel before being sent to retail stores 140 for implementation.

The effective date of specifies the date by which or on which a floor plan 200 or planogram 300 is to go into effect. The database 124 may include several floor plans 200 for a respective store 140 that each have a different effective date. Similarly, the database 126 may include several planograms 300 that each may have a different effective date. The management tool 170 may give floor plans 200 and planograms 300, which have been approved but have an effective date some time in the future, a status of Pending. Similarly, the management tool 170 may give a status of Live to floor plans 200 and planograms which have an effective date in the past but are still active (e.g., haven't been replaced by a newer floor plan 200 or planogram 300). Furthermore, the management tool 170 may give a status of Historic to floor plans 200 and planograms 300 which have an effective date in the past but are no longer active (e.g., have been replaced by another floor plan 200 or planogram 300).

As discussed in greater detail below, the floor plan database 124 and the planogram database 126 maintain several attributes that permit applying planograms 300 to multiple floor plans 200 and display fixtures 210. In one embodiment, the floor plan database 124 maintains several attributes for each display fixture 210, and the planogram database 126 may maintain the same attributes for each planogram 300. The attributes are defined and selected to ensure that a match of attributes between a planogram and a display fixture or in some cases a near match of attributes is sufficient to ensure that the planogram may be applied to the respective display fixture.

In particular, the attributes used by one embodiment are: fixture type, segmentation, height, width, assortment designation, presentation, configuration, and planogram group number. Fixture type refers to the type of display fixture such as, for example, gondola, baker's rack, table, display case, peg board, etc. Segmentation refers to units in which the fixture is assembled. For example, gondola are commonly assembled from 2.5′ or 4′ segments. Height refers to the height of the fixture such as, for example, 54″, 72″, or 84″. Width refers to the over linear footage of the fixture. For 2.5′ segments, linear values can be: 5′, 7.5′, 10, 12.5′, etc. Similarly, for 4′ segments, linear values can be 4′, 8′, 12′, etc. Depth refers to the depth of the fixture. For example, some shelves are 24″ deep, others may be 16″ deep. Assortment designation refers to the unique mix of products intended for a group of stores. Presentation refers to a different presentation or arrangement for the mix of products. Configuration permits specifying combinations of fixtures for a single assortment of product. Finally, planogram group number specifies a group of products set forth in the planogram.

Thus, fixture type, segmentation, height, width, and depth generally describe physical attributes of display fixtures 210. Assortment designation, presentation, and planogram group number generally describe the selection and arrangement of products on a particular fixture 210. The configuration attribute may effect both physical attributes (e.g. combinations of fixtures) as well as product arrangement (e.g., different arrangements for different combinations).

Referring now to FIG. 4, an attribute reconciliation process 400 of the management tool 170 is shown. In general, the attribute reconciliation process 400 receives floor plans 200 that have been placed in an attribute reconciliation process (ARP) queue 129 and manages relations between planograms 300 and floor plans 200. In one embodiment, the management tool 170 may place floor plans 200 or references to floor plans 200 in the ARP queue 129 in response to various triggering events. For example, the management tool 170 may place a reference to a floor plan 200 in the ARP queue 129 in response to opening and modifying an existing floor plan 200, creation of a floor plan 200 via a copy or version, deletion of a floor plan, moving the effective date 260 of a floor plan, and/or other triggering events.

The management tool 170 may periodically poll the ARP queue 129 to check for floor plans 200 to process. Alternatively, the ARP queue 129 may signal and/or otherwise request the management tool 170 to process a floor plan 200 when one or more floor plans 200 are present. Regardless, the management tool 170 at 402 may select and remove a floor plan 200 from the ARP queue 129 for processing. In one embodiment, the ARP queue 129 may be implemented as a first-in, first-out (FIFO) queue that stores floor plan database keys FP_{KEY}. In such an embodiment, the management tool 170 at 402 may select and remove the floor plan database key FP_{KEY} at a head of the ARP queue 129 and use the selected key to retrieve the respective floor plan 200 from the floor plan database 124. Other embodiments of the ARP queue 129 and/or management tool 170, however, may use other scheduling schemes to manage the queuing and subsequent selection of floor plans for processing such as priority encoding, round robin selection, random selection, etc.

After selecting a floor plan 200, the management tool 170 at 404 may determine whether the floor plan 200 is in use. To this end, the management tool 170 may determine whether or not the floor plan 200 is locked. For example, the floor plan 200 may be locked because personnel may have the floor plan 200 open and may be modifying one or more aspects of the floor plan 200. If in use, the management tool 170 at 406 may re-queue the selected floor plan 200 in the ARP queue 129 and exit the attribute reconciliation process 400.

At 408, the management tool 170 may determine whether the selected floor plan 200 has no planograms 300 assigned to its fixtures 210. If no planograms 300 are assigned, the management tool 170 at 410 may populate the floor plan 200 with planograms 300 based on SPA table 128 assignments and re-queue. Otherwise, the management system 170 at 412 initiates a loop over each referenced planogram of the floor plan 200.

The management tool 170 at 420 may determine whether a “Take All Changes” flag of the selected floor plan 200 is set. The “Take All Changes” flag provides a mechanism to override attribute reconciliation checks and forces changes through regardless of whether the changes cause a conflict. Accordingly, if set, the management tool 170 updates relationships in the SPA table 128 as specified in the selected floor plan. To this end, the management tool 170 may us a find or create method 500 described below with respect to FIG. 5 to find or create a planogram based on attributes specified by the floor plan.

At 430, the management tool 170 determines whether the SPA table 128 already includes a relationship between the floor plan and the referenced planogram. If not, the management tool 170 proceeds to introduce a relationship between the floor plan and a found or created planogram. In particular, the management tool may use the find or create method 500 to find or create a planogram based on attributes specified by the floor plan. The management tool 170 may then add, to the SPA table 128, a relationship between the found/created planogram and the floor plan.

At 440, the management tool 170 may determine whether the effective date of the floor plan has changed. If not, the management tool 170 may proceed to update a relation between the floor plan and a planogram. In particular, the management tool 170 may use the find or create method 500 to find or create a planogram based on attributes specified by the floor plan. The management tool 170 may then update a relationship in the SPA table 128 between the found/created planogram and the floor plan.

If the effective date of the floor plan has changed, then the management tool 170 at 450 may move the relation in the SPA table to reflect the change in effective date for the floor plan. In particular, the management tool 170 in the process of moving the effective date may add relationships to the SPA table 128, remove relationships from the SPA table 128, and update relationships in the SPA table 128 in order to appropriately account for the change in effective date of the floor plan and the planograms referenced by such floor plan.

At 460, the management tool 170 may determine whether each planogram referenced by the selected floor plan 200 has been processed. If each planogram reference has not been processed, then the management tool 170 may return to 412 to select another planogram reference for processing. Otherwise, the management tool 170 at 470 may determine whether the selected floor plan 200 is marked as Work In Progress. If a Work In Progress, the management tool 170 may cease further processing related to the selected floor plan 200. However, if not a Work In Progress, the management tool 170 may proceed to end relations at 480. In particular, the management tool 170 at 480 may remove relations from the SPA table 128 that are no longer needed due to various changes made to the selected floor plan 200.

Referring now to FIG. 5, a method 500 that may be used by the management tool 170 to find or create a planogram 300 for a floor plan 200 is shown. At 505, the management tool 170 may obtain attributes from the floor plan 200. As noted above, the floor plan 200 for a particular display fixture 210 may specify several attributes to be met by a planogram for the display fixture. For example, the floor plan 200 may specify a planogram group number, a fixture type, segmentation, height, depth, presentation, assortment designation, and configuration.

Based on such attributes, the management tool 170 at 510 may attempt to locate a planogram in the planogram database 126 that satisfies all of such attributes plus (i) has a width that either matches a new width or existing width provided by the floor plan; (ii) has a status of Live, Pending, Work In Progress, or Awaiting Approval; and (iii) (a) for a Live floor plan, has an effective data equal to a predetermined day of the week (e.g., the upcoming Sunday) or in the past; or (b) for a non-Live floor plan, an effective date equal to or prior to the effective date of the floor plan. The management tool 170 may further select from among the one or more identified planograms that satisfy the above criteria the planograms with the earliest effective date and then based on the following status order: Work In Progress, Awaiting Approval, Pending, and then Live. If the management system 170 is able to marry an existing planogram of the planogram database 126 with the floor plan 200 based on satisfying the above attributes and selection criteria, then the management tool 170 at 515 may proceed based on the database key POG_{KEY} for the identified planogram without creating and storing a new planogram in the planogram database 126.

However, if the management system 170 is unable to locate a planogram at 510, the management tool 170 may systematically continue to relax the criterion to be satisfied by planograms of the planogram database 126 until a suitable planogram is found or it's determined that new planogram is to be created. To this end, the management tool 170 at 520 may drop the depth attribute from the criteria to be matched by the planograms of the planogram database 126. If the management tool 170 at 520 finds a planogram that satisfies the relaxed criteria, then the management tool 170 at 515 may proceed based on the database key POG_{KEY} for the identified planogram without creating and storing a new planogram in the database 126.

Otherwise, the management tool 170 may continue to further relax the criterion in order to identify an existing planogram. In particular, the management tool 170 at 525 may further drop the presentation criteria. At 530, the management tool 170 may further drop the width criteria. Finally, the management tool 170 at 535 may further drop the assortment designation criteria.

If the management tool 170 at 525, 530, or 535 locates a planogram, then the management tool 170 at 545 may copy the identified planogram. Moreover, the management tool 170 at 550 may update the effective date, assortment designation, width, and presentation to correspond to such value provided by the floor plan. Finally, the management tool 170 at 555 may remove products from the planogram prior to storing in the database 126 since personnel will need to revise the planogram to account for the changes.

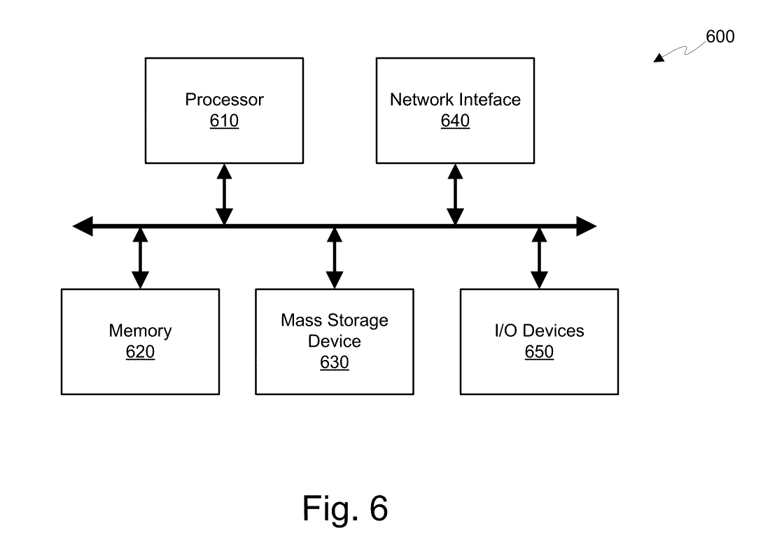

As noted above, the floor plan and planogram management system 100 may include computer systems 110, 120. FIG. 6 depicts an embodiment of a computer system 600 suitable for implementing the computer systems 110, 120. As shown, the computer system 600 may include a processor 610, a memory 620, a mass storage device 630, a network interface 640, and various input/output (I/O) devices 650. The processor 610 may be configured to execute instructions, manipulate data and generally control operation of other components of the computer system 600 as a result of its execution. To this end, the processor 610 may include a general purpose processor such as an x86 processor or an ARM processor which are available from various vendors. However, the processor 610 may also be implemented using an application specific processor and/or other logic circuitry.

The memory 620 may store instructions and/or data to be executed and/or otherwise accessed by the processor 610. In some embodiments, the memory 620 may be completely and/or partially integrated with the processor 610.

In general, the mass storage device 630 may store software and/or firmware instructions which may be loaded in memory 620 and executed by processor 610. The mass storage device 630 may further store various types of data which the processor 610 may access, modify, and/otherwise manipulate in response to executing instructions from memory 620. To this end, the mass storage device 630 may comprise one or more redundant array of independent disks (RAID) devices, traditional hard disk drives (HDD), solid-state device (SSD) drives, flash memory devices, read only memory (ROM) devices, etc.

The network interface 640 may enable the computer system 600 to communicate with other computer systems directly and/or via network 150. To this end, the networking interface 640 may include a wired networking interface such as an Ethernet (IEEE 802.3) interface, a wireless networking interface such as a WiFi (IEEE 802.11) interface, a radio or mobile interface such as a cellular interface (GSM, CDMA, LTE, etc), and/or some other type of networking interface capable of providing a communications link between the computer system 600 and network 650 and/or another computer system.

Finally, the I/O devices 650 may generally provide devices which enable a user to interact with the computer system 600 by either receiving information from the computer system 600 and/or providing information to the computer system 600. For example, the I/O devices 650 may include display screens, keyboards, mice, touch screens, microphones, audio speakers, etc.

While the above provides general aspects of a computer system 600, those skilled in the art readily appreciate that there may be significant variation in actual implementations of a computer system. For example, a smart phone implementation of a computer system may use different components and may have a different architecture than a database server implementation of a computing device. However, despite such differences, computer systems generally include processors that execute software and/or firmware instructions in order to implement various functionality. As such, the above described aspects of the computer system 600 are not presented from a limiting standpoint but from a generally illustrative standpoint. Aspects of the present application may find utility across a vast array of different computer systems and the intention is not to limit the scope of the present application to a specific computer system, computing device, and/or computing platform beyond any such limits that may be found in the appended claims.

Various embodiments of the invention have been described herein by way of example and not by way of limitation in the accompanying figures. For clarity of illustration, exemplary elements illustrated in the figures may not necessarily be drawn to scale. In this regard, for example, the dimensions of some of the elements may be exaggerated relative to other elements to provide clarity. Furthermore, where considered appropriate, reference labels have been repeated among the figures to indicate corresponding or analogous elements.

Moreover, certain embodiments may be implemented as a plurality of instructions on a non-transitory, computer readable storage medium such as, for example, flash memory devices, hard disk devices, compact disc media, DVD media, EEPROMs, etc. Such instructions, when executed by one or more computing devices, may result in the one or more computing devices promoting the sale of products and/or one or more of the other aspects of the e-commerce environment 10 described above.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment or embodiments disclosed, but that the present invention encompasses all embodiments falling within the scope of the appended claims.

What is claimed is:

1. A computer-implemented method, comprising:
identifying, from a floor plan, attributes for a display fixture and products to be displayed by the display fixture;
obtaining a planogram based on an electronic database of planograms and the identified attributes of the display fixture and products to be displayed; and
creating a relationship between the floor plan and the obtained planogram for the display fixture.

2. The computer-implemented method of claim 1, wherein said obtaining comprises:
identifying a planogram in the electronic database having attributes that match the identified attributes for the display fixture and products to be displayed; and
selecting the identified planogram as the obtained planogram for the display fixture.

3. The computer-implemented method of claim 1, wherein said obtaining comprises:
identifying a planogram in the electronic database having attributes that match a subset of the identified attributes for the display fixture and products to be displayed;
copying the identified planogram to create a new planogram in the electronic database;
updating the new planogram to match the identified attributes for the display fixture and products to be displayed; and
selecting the new planogram as the obtained planogram for the display fixture.

4. The computer-implemented method of claim 1, further comprising removing products from the new planogram.

5. The computer-implemented method of claim 1, wherein:
the floor plan specifies the attributes for the display fixture and products to be displayed; and
the attributes include at least a fixture type and width for the display fixture.

6. The computer-implemented method of claim 1, wherein:
the floor plan specifies the attributes for the display fixture and products to be displayed; and
the attributes include at least an assortment designation for the products to be displayed.

7. A non-transitory, computer readable storage medium, comprising a plurality of instructions that in response to being executed results in a computer system:
retrieving a floor plan based on a queue of floor plans to be processed;
identifying, from the retrieved floor plan, attributes for a display fixture of the floor plan and products to be displayed by the display fixture;
obtaining a planogram based on an electronic database of planograms and the identified attributes; and
updating an assignment table to reflect a relationship between the floor plan and the obtained planogram for the display fixture.

8. The non-transitory, computer readable storage medium of claim 7, wherein the plurality of instructions further result in the computer system:
identifying a planogram in the electronic database having attributes that match the identified attributes for the display fixture and products to be displayed; and
selecting the identified planogram as the obtained planogram for the display fixture.

9. The non-transitory, computer readable storage medium of claim 7, wherein the plurality of instructions further result in the computer system:
identifying a planogram in the electronic database having attributes that match a subset of the identified attributes for the display fixture and products to be displayed;
copying the identified planogram to create a new planogram in the electronic database;
updating the new planogram to match the identified attributes for the display fixture and products to be displayed; and
selecting the new planogram as the obtained planogram for the display fixture.

10. The non-transitory, computer readable storage medium of claim 9, wherein the plurality of instructions further result in the computer system removing products from the new planogram.

11. The non-transitory, computer readable storage medium of claim 7, wherein:
the floor plan specifies the attributes for the display fixture and products to be displayed; and
the attributes include at least a fixture type and width for the display fixture.

12. The non-transitory, computer readable storage medium of claim 7, wherein:
the floor plan specifies the attributes for the display fixture and products to be displayed; and
the attributes include at least an assortment designation for the products to be displayed.

13. A computer system, comprising
one or more storage devices that store retail store database, a floor plan database, a planogram database, an assignment table, and a queue, wherein the retail store database comprises information for a plurality of retail stores, the floor plan database comprises a plurality of floor plans for the plurality of retail stores, the planogram database comprises a plurality of planograms, the assignment table stores a plurality of relationships that relate planograms of the planogram database to floor plans of the floor plan database, and the queue identifies floor plan of the floor plan database to be processed; and
a processor that:
retrieves from the floor plan database a floor plan identified by the queue;
identifies, from the retrieved floor plan, attributes for a display fixture of the floor plan and products to be displayed by the display fixture;
obtains a planogram based planograms of the planogram database and the identified attributes; and
updates the assignment table to reflect a relationship between the retrieved floor plan and the obtained planogram for the display fixture.

14. The computer system of claim 13, wherein the processor further:
identifies a planogram of the planogram database having attributes that match the identified attributes for the display fixture and products to be displayed; and
selects the identified planogram as the obtained planogram for the display fixture.

15. The computer system of claim 13, wherein the processor further:
identifies a planogram of the planogram database having attributes that match a subset of the identified attributes for the display fixture and products to be displayed;
copies the identified planogram to create a new planogram in the planogram database;
updates the new planogram to match the identified attributes for the display fixture and products to be displayed; and
selects the new planogram as the obtained planogram for the display fixture.

16. The computer system of claim 14, wherein the processor further removes products from the new planogram.

17. The computer system of claim 13, wherein:
the retrieved floor plan specifies the attributes for the display fixture and products to be displayed; and
the attributes include at least a fixture type and width for the display fixture.

18. The computer system of claim 13, wherein:
the retrieved floor plan specifies the attributes for the display fixture and products to be displayed; and
the attributes include at least an assortment designation for the products to be displayed.
